(19) United States
(12) Patent Application Publication
(10) Pub. No.: US 2025/0102307 A1
(43) Pub. Date: Mar. 27, 2025

(54) Device and Method for Determining a Reference Travel Path for a Road Surface Section

(71) Applicant: Bayerische Motoren Werke Aktiengesellschaft, Muenchen (DE)

(72) Inventors: Martin LIEBNER, Muenchen (DE); Benedict DINGFELDER, Garching (DE); David PANNEN, Muenchen (DE)

(21) Appl. No.: 18/832,220

(22) PCT Filed: Dec. 1, 2022
(86) PCT No.: PCT/EP2022/083988

§ 371 Date: Jul. 23, 2024

(30) Foreign Application Priority Data
Jan. 24, 2022 (DE) 10 2022 101 540.8

(51) Int. Cl. G01C 21/30; B60W 60/00

(52) U.S. Cl. CPC G01C 21/30; B60W 60/001; B60W 2556/40

(57) ABSTRACT

A device for determining a reference travel path for a road section determines a plurality of measured travel paths of one or more vehicles for a corresponding plurality of passages through the road section, and subdivides a course of the road section into a sequence of support point levels. For each of the plurality of measured travel paths, the device determines a sequence of cut points of the respective measured travel path with the corresponding sequence of support point levels and, for each sequence of support point levels, determines a respective amount of support points based on the determined cut points with the respective support point levels. The device determines at least one reference travel path for the road section based on the sequence of sets of support points for the corresponding sequence of support point levels.

### BACKGROUND AND SUMMARY

The invention relates to methods and corresponding devices that make it possible to determine a typical driving path of vehicles on a road in the form of lanes of the road.

In order to partially or fully automate control of a vehicle in the longitudinal and/or transverse direction, it is advantageous to have available a high-accuracy geographical map of the surroundings. A map with standard accuracy (SD: “standard definition”), which may be used for example for route guidance of the vehicle to a predetermined destination, usually has an accuracy in the range of around one meter to around ten meters. A high-accuracy map (HD: “high definition”) should usually deviate from reality by only less than around one meter. HD and SD maps may also differ from one another other than in terms of accuracy, for example with regard to the information they each contain.

If the vehicle is driving for example on a road with a plurality of lanes, then the HD map may display lane boundaries in order to allow a distinction as to the lane in which the vehicle is driving. Visual indicators may be used to determine a lane boundary, for example lane markings. A lane marking usually comprises a line applied directly to the road.

Determining an HD map using a surveying vehicle is complex. An HD map may alternatively be created on the basis of sensor-based recordings of lane boundaries that are determined by a fleet of vehicles driving on the road in any case.

An HD map may thus, for a road, display the profile of lane boundaries between the one or more lanes of the road. This information may be used by a driving function to drive a vehicle, longitudinally and/or transversely, at least partially or fully automatically along the road, in particular along a lane. For this purpose, a target trajectory for the vehicle may be determined on the basis of the map data from the HD map. The target trajectory may in this case for example run centrally between the lane markings indicated by the map data. The vehicle may then be driven, longitudinally and/or transversely, automatically along the determined target trajectory.

Using the profile of the lane boundaries to determine a target trajectory may lead to determining a target trajectory that, although it runs between different lane boundaries, does not run on an available lane (as may be the case for example on a motorway not separated by structures). Furthermore, in some sections of a road, there may be no lane boundary, or not enough lane boundaries, able to be recorded using sensors (for instance ahead of a toll station, within an intersection or on a country road). As a result, it is not possible to determine a target trajectory, or not possible to determine a realistic target trajectory. It may also be the case that a target trajectory determined on the basis of the profile of lane boundaries recorded using sensors is perceived to be uncomfortable by the user of a self-driving vehicle.

The present document deals with the technical problem of efficiently and precisely determining map data of a digital (HD) map for a road that enable reliable and comfortable automated longitudinal and/or transverse guidance of a vehicle.

The object is achieved by the present disclosure. Advantageous embodiments are also described in the present disclosure. It is pointed out that additional features of a patent claim dependent on an independent patent claim, without the features of the independent patent claim or only in combination with a subset of the features of the independent patent claim, may form a separate invention independent of the combination of all of the features of the independent patent claim, that may be made into the subject matter of an independent claim, a divisional application or a subsequent application. This applies analogously to the technical teaching described in the description, which teaching may form an invention independent of the features of the independent patent claims. It is pointed out in particular that the features of the devices and methods described in this document may be combined with one another as desired. In particular, the features of a first method or of a first device may be applied on their own or in combination to a different second method or to a different second device as well.

According to one aspect, a description is given of a device for determining a reference driving path for a road section in a road network. The road section may have one or more different lanes. A road section may for example have a length between 20 and 50 meters.

The device is configured to determine a multiplicity of measured driving paths of one or more vehicles for a corresponding multiplicity of runs through the road section. In this case, for each run, a measured driving path may be transmitted, via a (wireless) communication connection, from the respective vehicle to the device and received by the device. It is possible to determine for example 5 or more or 10 or more or 20 or more measured driving paths.

A measured driving path of a vehicle may in each case comprise a sequence of measurement points of the position of the vehicle, in particular the position of a particular reference point (for example the center point of an axle) of the vehicle, in a run through the road section. The measurement points may be provided with a particular spatial resolution, for instance of 1 measurement point per meter or more. As an alternative or in addition, a measured driving path of a vehicle may indicate the actual driving trajectory of the vehicle in a run through the road section. It is thus possible to determine measured driving paths that each indicate the trajectory along which the individual vehicles are driven (manually) through the road section. The measured driving paths thus make it possible to describe the actual driving behavior of vehicles in the road section.

The device is furthermore configured to divide the profile of the road section into a sequence of interpolation point planes. In other words, interpolation point planes may be arranged along the profile of the road section (for example equidistantly). The sequence of (two-dimensional) interpolation point planes may in this case be arranged such that directly consecutive interpolation point planes along the profile of the road section are each at a predefined (constant) distance from one another, for instance between 1 and 3 meters. By way of example, the profile of the road section may be divided into 10 or more or into 20 or more different interpolation point planes. As an alternative or in addition, the sequence of interpolation point planes may be arranged such that the individual interpolation point planes are each arranged perpendicular to the profile of the road section (at the respective location of the interpolation point plane).

The device may be configured, on the basis of a digital map (for example on the basis of a 2D map) in relation to the road section, to determine a map profile of the road section recorded in the digital map. The map profile of the road section may then be used as profile for the division of the road section into the sequence of interpolation point planes or for the arrangement of the sequence of interpolation point planes. As an alternative, as set forth below, a reference profile of the road section may be determined (on the basis of the multiplicity of measured driving paths) and used for the arrangement of the interpolation point planes.

The two-dimensional interpolation point planes may be used to analyze the multiplicity of measured driving paths consistently in order to determine at least one reference driving path for the road section that indicates the typical driving behavior of vehicles in the run through the road section. In this case, a reference driving path may in particular describe the center line of a lane of the road within the road section.

The device may furthermore be configured, for each of the multiplicity of measured driving paths, to determine a respective sequence of points of intersection of the respective measured driving path with the corresponding sequence of interpolation point planes. It is thus possible to determine the locations (that is to say points of intersection) at which the individual measured driving paths pass through the individual interpolation point planes.

The device may furthermore be configured, for each of the sequence of interpolation point planes, to determine a respective set of interpolation points (that is to say zero, one or more interpolation points) on the basis of the determined points of intersection with the respective interpolation point plane. The set of interpolation points for an interpolation point plane may be determined on the basis of a clustering algorithm, in particular on the basis of a Density-Based Spatial Clustering of Applications with Noise (DBSCAN) algorithm, for clustering the multiplicity of determined points of intersection with the interpolation point plane. An interpolation point may possibly be determined as a (trimmed) average of the points of intersection of a respective cluster.

When determining the interpolation points, one or more points of intersection may possibly each be identified as outliers and remain unconsidered during the clustering and/or when determining the interpolation points. In other words, the device may be configured to identify one or more points of intersection from the multiplicity of points of intersection with an interpolation point plane as outliers. The one or more points of intersection identified as outliers may then remain unconsidered when determining the set of interpolation points for the respective interpolation point plane.

The device may thus be configured to determine a subset (in particular a cluster) of points of intersection for an interpolation point from the multiplicity of determined points of intersection with an interpolation point plane, in particular on the basis of a clustering algorithm. The interpolation point may then be determined as an average, in particular as a trimmed average, of the subset of points of intersection. In this case, when determining the trimmed average, the x % smallest and/or largest points of intersection (per coordinate within the respective interpolation point plane) may remain unconsidered in the averaging (for example with x between 5 and 15).

The device may furthermore be configured to determine at least one reference driving path for the road section on the basis of the sequence of sets of interpolation points for the corresponding sequence of interpolation point planes. For this purpose, the device may be configured to assign a respective interpolation point from the set of interpolation points of the respective interpolation point plane under consideration to the reference driving path to be determined, sequentially along the sequence of interpolation point planes.

For this purpose, the device may be configured, for a first interpolation point in a particular interpolation point plane from the sequence of interpolation point planes, to determine a first subset of the measured driving paths of the one or more points of intersection from which the first interpolation point of the particular interpolation point plane was determined. In particular, it is possible to determine which points of intersection from which one or more measured driving paths were combined, in particular clustered, to form the first interpolation point.

The device may furthermore be configured to determine a second subset of measured driving paths of the one or more points of intersection from which an interpolation point of another interpolation point plane (which is arranged for example directly before the particular interpolation point plane) that was already assigned to the reference driving path was determined. It is thus possible to determine which points of intersection from which one or more measured driving paths were combined, in particular clustered, to form the interpolation point of the other interpolation point plane that was already assigned to the reference driving path.

The first interpolation point may then be assigned to the reference driving path on the basis of the first and second subset of measured driving paths, in particular on the basis of a Jaccard coefficient of the first and second subset of measured driving paths. In this case, the interpolation point from the particular interpolation point plane may in particular be assigned to the reference driving path for which the respectively determined subset of measured driving paths has the greatest possible, in particular the greatest overlap with the second subset of measured driving paths. A sequential approach may accordingly be adopted for the sequence of interpolation point planes.

Furthermore, the assigned interpolation point of the respective interpolation point plane under consideration may be joined, by a path segment, to the assigned interpolation point of the preceding interpolation point plane arranged before the interpolation point plane under consideration. A reference driving path may thus be formed sequentially by the path segments between the respectively assigned interpolation points. Accordingly, multiple reference driving paths may possibly be determined for different lanes of the road section.

A reference driving path determined by the device may be designed such that the reference driving path is able to be used as target trajectory for an at least partially self-driving vehicle in a run through the road section. As an alternative or in addition, the determined reference driving path may indicate a sequence of target positions of the vehicle, in particular a sequence of target positions of a reference point of a vehicle, in a run through the road section. As an alternative or in addition, the determined reference driving path may be designed such that the reference driving path is able to be used in an augmented reality display and/or that the reference driving path is able to be used for an estimate of the arrival time of a driving route (that runs through the road section).

The device may be configured to determine an empirical speed for a path segment between a first interpolation point of a first interpolation point plane and a second interpolation point of a (different) second interpolation point plane of the reference driving path. An empirical speed may be determined accordingly for each path segment of the reference driving path. It is thus possible to determine a typical profile of the (empirical) speed of vehicles along the reference driving path. For this purpose, it is possible to provide, for the multiplicity of measured driving paths, respective speed values along the respective measured driving path (for example speed values for the sequence of measurement points along the respective measured driving path).

To determine the empirical speed for the path segment between the first and the second interpolation point, it is possible to determine first speed values for the one or more points of intersection of a first subset of measured driving paths from which the first interpolation point was determined (in particular clustered). It is also possible to determine second speed values for the one or more points of intersection of a second subset of measured driving paths from which the second interpolation point was determined (in particular clustered). The empirical speed for the path segment may then be determined precisely on the basis of the first and second speed values, in particular on the basis of an average of the first and/or second speed values.

The profile of the empirical speed along a reference driving path may be taken into consideration to determine a target trajectory of an at least partially self-driving vehicle. The quality of autonomous driving functions is thus able to be further improved.

The device may furthermore be configured to provide the at least one determined reference driving path as map data in relation to the road section for a digital map (in particular for an HD map). In this case, the respective profile of the determined empirical speed along the reference driving path may be provided for the reference driving path.

A description is thus given of a device that is designed to evaluate driving paths recorded (measured) by vehicles in order to determine one or more reference driving paths that describe the profile and the absolute position of lanes (actually driven in), in particular the profile and the absolute position of the center line of lanes. The device may in this case be configured to determine a reference driving path independently of road markings of the road section that are recorded using sensors. As an alternative or in addition, the device may be configured to determine a reference driving path on the basis of the multiplicity of measured driving paths as well when the road section does not have any road markings able to be recorded using sensors, in particular any road markings able to be recorded using sensors for identifying one or more lanes. This thus enables particularly efficient and robust determination of the profile of lanes on a road.

According to a further aspect, a description is given of a (further) device for determining a reference driving path for a road section (referred to below as “core road section”). The device is configured to determine a multiplicity of measured driving paths of one or more vehicles for a corresponding multiplicity of runs through the core road section (for example to receive them from one or more vehicles).

The device may furthermore be configured to assign each of the multiplicity of measured driving paths to a respective section sequence from a set of different section sequences in order to determine a respective subset of measured driving paths for each section sequence of the set of section sequences. In other words, each measured driving path may be assigned to in each case exactly one section sequence. The different section sequences from the set of section sequences may be determined for example on the basis of a digital map (for example an SD map) in relation to the road network in the surroundings of the core road section. It is possible to consider for example 2 or more or 5 or more different section sequences. Each subset of measured driving paths may contain for example 2 or more or 5 or more measured driving paths.

The different section sequences may each contain the core road section and at least one surrounding road section arranged directly in front of and/or directly behind the core road section in the direction of travel. The individual section sequences may in particular each, in addition to the core road section, contain N surrounding road sections in front of and M surrounding road sections behind the core road section, for example where N and/or M are each 1 or more or 2 or more. In this case, either N or M may possibly be zero.

The different section sequences may contain at least partially different surrounding road sections (that is to say short road sections) in the surroundings of the core road section. As an alternative or in addition, the different surrounding road sections may have different spatial orientations (in particular different directions of travel) relative to the core road section.

The different section sequences may thus have different directions from which vehicles are able to drive into the core road section and/or into which vehicles are able to drive out of the core road section. These different directions may influence the (optimum and/or typical) trajectory of vehicles in the core road section.

The device may be configured, for each section sequence from the set of section sequences, to determine a reference driving path for the core road section on the basis of the respective subset of measured driving paths (in particular restricted to the respective subset). In other words, the determination of the reference driving path in the core road section for a particular section sequence may be restricted to the determined subset of measured driving paths for the particular section sequence.

The method described in this document may be used to determine a reference driving path. The device may in particular be configured to determine a reference driving path for the core road section such that the reference driving path is defined and/or described by a sequence of interpolation points in a corresponding sequence of interpolation point planes that is arranged along the profile of the core road section.

The device may be configured, in order to determine a reference driving path for a particular section sequence, for each of the measured driving paths of the subset of measured driving paths for the particular section sequence, to determine a respective sequence of points of intersection of the respective measured driving path with the corresponding sequence of interpolation point planes. A respective set of interpolation points may then be determined for each of the sequence of interpolation point planes on the basis of the determined points of intersection with the respective interpolation point plane. The reference driving path in the core road section for the particular section sequence may furthermore be determined on the basis of the sequence of sets of interpolation points for the corresponding sequence of interpolation point planes.

A description is thus given of a device that makes it possible to take into consideration different directions in which a core road section is driven into and/or out of when evaluating measured driving paths. It is then possible to determine respective dedicated reference driving paths for the different driving-in and/or driving-out directions. This makes it possible to efficiently increase the accuracy of the determined profiles of lanes.

The device may be configured to arrange the sequence of interpolation point planes such that the first interpolation point plane of the sequence of interpolation point planes (the first interpolation point plane in relation to the direction of travel through the core road section) is at a predefined distance (for example half the distance between the interpolation point planes) from the start of the profile of the core road section. As an alternative or in addition, the device may be configured to arrange the sequence of interpolation point planes such that the last interpolation point plane of the sequence of interpolation point planes (the last interpolation point plane in relation to the direction of travel through the core road section) is at a predefined distance (for example half the distance between interpolation point planes) from the end of the profile of the core road section. This makes it possible to efficiently and robustly increase the quality of the juxtaposition of reference driving paths for consecutive road sections.

The device may be configured to provide the set of determined reference driving paths for the corresponding set of different section sequences as map data in relation to the core road section for a digital map (for example for an HD map). This makes it possible to increase the quality of automated driving functions (based on the provided map data).

The device may be configured, for each of the multiplicity of measured driving paths, to determine a respective extended measured driving path that, in addition to describing the run through the core road section, also describes the run through at least one surrounding road section arranged directly before and/or directly after the core road section. It is in particular possible to determine extended measured driving paths that extend over the length of the section sequences. It is then possible, in a particularly efficient and precise way, to assign the multiplicity of measured driving paths on the basis of the corresponding multiplicity of extended measured driving paths to the individual section sequences from the set of different section sequences.

The device may be configured, for a particular section sequence that contains the core road section and a particular surrounding road section arranged directly after the core road section, to determine a following reference driving path for the particular surrounding road section. The reference driving path for the core road section may then be joined to the following reference driving path for the particular surrounding road section in order to determine a sequence driving path for the particular section sequence. As an alternative, reference driving paths may be juxtaposed in the opposite direction, such that the reference driving path for the core road section is joined to the preceding reference driving path for the particular surrounding road section arranged directly before the core road section. This makes it possible to efficiently and precisely determine continuous driving paths and thus the profile of lanes through the road network.

The device may be configured to determine a set of following reference driving paths for the particular surrounding road section arranged directly after the core road section. The device may furthermore be configured to assign a following reference driving path from the set of reference driving paths for the particular surrounding road section to a particular reference driving path from the set of reference driving paths for the core road section using an (assignment) distance metric. In this case, the (assignment) distance metric may depend on the distance between the end point (that is to say between the position of the end point) of the particular reference driving path and the starting point (that is to say the position of the starting point) of the following reference driving path. The particular reference driving path may then be joined (by a path segment) to the associated following reference driving path in order to determine a sequence driving path for a sequence of road sections. This makes it possible to efficiently and precisely determine continuous driving paths and thus the profiles of lanes through the road network.

The distance metric may in particular depend on a Euclidean distance between the end point of the particular reference driving path and the starting point of the following reference driving path. As an alternative or in addition, the distance metric may depend on a Jaccard coefficient of a first subset of measured driving paths and a second subset of measured driving paths. The first subset of measured driving paths may in this case comprise the one or more measured driving paths whose corresponding one or more points of intersection with the last interpolation point plane of the respective sequence of interpolation point planes were combined, in particular clustered, to form the end point of the particular reference driving path. The second subset of measured driving paths may comprise the one or more measured driving paths whose corresponding one or more points of intersection with the first interpolation point plane of the respective sequence of interpolation point planes were combined, in particular clustered, to form the starting point of the following reference driving path.

In other words, the device may be configured to determine a first subset of the multiplicity of measured driving paths that comprises (only) the one or more measured driving paths from which the end point of the particular reference driving path was determined. The device may furthermore be configured to determine a second subset of the multiplicity of measured driving paths that comprises (only) the one or more measured driving paths from which the starting point of the following reference driving path was determined. The distance metric in relation to the distance between the end point of the particular reference driving path and the starting point of the following reference driving path may then be determined precisely on the basis of the first subset and the second subset of measured driving paths, in particular on the basis of the Jaccard coefficient of the first and second subset of measured driving paths.

According to a further aspect, a description is given of a control unit for the at least partially automated longitudinal and/or transverse guidance of a (motor) vehicle along a driving route through a road network. The control unit may be part of the vehicle. The control unit may be configured (for example on the basis of map data from a digital map of the road network) to determine a set of different reference driving paths for a corresponding set of different section sequences for a future run through a core road section of the road network on the driving route. In this case, the different section sequences may each contain the core road section and at least one surrounding road section arranged directly in front of and/or directly behind the core road section in the direction of travel of the vehicle.

The control unit is furthermore configured to identify a section sequence from the set of different section sequences on the basis of the driving route. In this case, it is possible in particular to identify the section sequence that corresponds to the driving route of the vehicle, that is to say along which the vehicle will drive through the core road section.

The control unit may furthermore be configured to determine a target trajectory of the vehicle for at least partially automated longitudinal and/or transverse guidance of the vehicle in a run through the core road section on the basis of the reference driving path for the identified section sequence. The vehicle may then be guided at least partially automatically along the determined target trajectory through the core road section. This makes it possible to efficiently and reliably increase the quality of an automated driving function.

According to a further aspect, a description is given of a device for determining a reference driving path for a road section. The device may be configured to determine a multiplicity of measured driving paths of one or more vehicles for a corresponding multiplicity of runs through the road section (for example to receive them from one or more vehicles).

The device may furthermore be configured to determine a reference profile of the road section on the basis of the multiplicity of measured driving paths.

For this purpose, the device may be configured to determine a respective overall length for at least a subset of the multiplicity of measured driving paths. The subset may comprise for example 70% or more of the measured driving paths from the multiplicity of measured driving paths. The subset may furthermore comprise for example 2 or more or 5 or more measured driving paths.

It is then possible, for each measured driving path from the subset of measured driving paths, to determine a respective sequence of path points on a corresponding sequence of consecutive running length positions. In this case, the consecutive running length positions may be relative to the overall length of the respective measured driving path (for example on a sequence of percentage points of the respective overall length). By way of example, a running length position may correspond in each case to y % of the respective overall length. The sequence of consecutive running length positions may then contain different (possibly equidistant) values of y (for example 10, 20, 30, . . . , 100). The sequence of consecutive running length positions may comprise for example 5 or more or 10 or more different running length positions.

The device may be configured, for each of the running length positions, on the basis of the respective path points of the measured driving paths, in particular on the basis of an average, for instance on the basis of a trimmed average, of the path points of the measured driving paths, to determine a corresponding path point of the reference profile, in order to determine a sequence of path points of the reference profile on the corresponding sequence of consecutive running length positions of the reference profile. The reference profile may then be described by the sequence of path points.

The device may be configured, for an (in particular for each individual) running length position from the sequence of consecutive running length positions, to identify one or more path points of the measured driving paths as outliers. The one or more identified path points of the measured driving paths may then remain unconsidered when determining the corresponding path point of the reference profile. This makes it possible to further increase the quality of the determined reference profile.

The device may be configured to identify one or more measured driving paths from the multiplicity of measured driving paths as outliers. The one or more identified, measured driving paths may then remain unconsidered when determining the reference profile of the road section. This makes it possible to further increase the quality of the determined reference profile.

The device may furthermore be configured to arrange a sequence of interpolation point planes along the reference profile. A respective sequence of points of intersection of the respective measured driving path with the corresponding sequence of interpolation point planes may then be determined for each of the multiplicity of measured driving paths. Furthermore, at least one reference driving path for the road section may be determined on the basis of the multiplicity of determined sequences of points of intersection for the corresponding multiplicity of measured driving paths.

Determining a reference profile for a road section makes it possible to further increase the quality of the determined reference driving paths. It is thus possible in particular to determine reference driving paths for consecutive road sections that are able to be juxtaposed consistently with one another in order to determine a sequence driving path.

The device may be configured, on the basis of a digital map (for example on the basis of an SD map) in relation to the road section, to determine a map profile of the road section recorded in the digital map. The reference profile of the road section may then be determined with increased accuracy on the basis of the map profile as well.

The device may in particular be configured to determine the start and/or the end (that is to say the position of the start and/or the end) of the map profile. It is then possible to determine a corresponding start and/or a corresponding end (that is to say the respective position of the start or end) of the reference profile based on a distance metric. In this case, the start and/or the end of the reference profile may be determined such that the distance metric is reduced, in particular minimized. This makes it possible to further increase the quality of the determined reference profile.

The distance metric for determining the start of the reference profile may depend on the distance between the start of the map profile and the start, to be determined, of the reference profile. The distance metric for determining the start of the reference profile may furthermore depend on the deviation of the orientation of the map profile at the start of the map profile and the orientation of the reference profile at the start, to be determined, of the reference profile.

The distance metric for determining the end of the reference profile may accordingly depend on the distance between the end of the map profile and the end, to be determined, of the reference profile. The distance metric for determining the end of the reference profile may furthermore depend on the deviation of the orientation of the map profile at the end of the map profile and the orientation of the reference profile at the end, to be determined, of the reference profile.

Using such a distance metric makes it possible to determine reference driving paths that are able to be juxtaposed particularly reliably and consistently.

According to a further aspect, a description is given of a device for determining a reference profile of a core road section. In this case, the device may be configured to determine a respective specific reference profile of the core road section for one or more different section sequences (which each comprise the core road section). The specific reference profile for a particular section sequence may then be used to determine the reference driving path for this particular section sequence. This makes it possible to further increase the quality of the determined reference driving paths for a road section.

As an alternative or in addition, the device may be configured to provide the one or more determined reference profiles for the core road section as map data of a digital map (as an alternative or in addition to the map profiles). As an alternative or in addition, the device may be configured to have the effect that a vehicle is operated on the basis of a determined reference profile of the core road section when driving through the core road section.

The device may be configured to determine a multiplicity of measured driving paths of one or more vehicles for a corresponding multiplicity of runs through the core road section. The device may furthermore be configured to assign a first subset of measured driving paths from the multiplicity of measured driving paths to a first section sequence from a set of different section sequences. In this case, the different section sequences may each contain the core road section and at least one surrounding road section arranged directly in front of and/or directly behind the core road section in the direction of travel.

It is then possible to determine a first reference profile of the core road section for the first section sequence (possibly solely) on the basis of the first subset of measured driving paths for the first section sequence. Specific reference profiles may accordingly be determined for the one or more other section sequences.

The first reference profile for the first section sequence may be determined as described in this document. In this case, (possibly only) the first subset of measured driving paths is taken into consideration to determine the first reference profile. This may have the effect that the first reference profile is adapted specifically to the profile of the first section sequence. As a result, it is possible to increase the quality of the determined first reference profile and the quality of the reference driving path determined based on the first reference profile (in particular in relation to the juxtaposition of reference driving paths for a section sequence).

It is thus possible to determine a respective specific reference profile of the core road section for the different section sequences. The section sequence-specific reference profile may then be used to determine the corresponding section sequence-specific reference driving path. This makes it possible to increase the quality of the determined reference driving paths for the core road section to a considerable extent.

The first section sequence may for example contain the core road section and a particular surrounding road section arranged directly after or before the core road section. The device may be configured to determine a reference driving path for the core road section on the basis of the first subset of measured driving paths and using the first reference profile (as described in this document). The device may furthermore be configured to determine a following or preceding reference driving path for the particular surrounding road section. The reference driving path for the core road section may then be joined to the following or preceding reference driving path for the particular surrounding road section in order to determine a sequence driving path for the first section sequence. Using the first reference profile to determine the reference driving path for the core road section makes it possible to determine the sequence driving path particularly precisely.

The device may be configured to determine an empirical speed for a segment of the first reference profile between a first path point and a (directly following) second path point of the first reference profile. The first path point may in this case be arranged at a first running length position, and the second path point may be arranged at a second running length position. Accordingly, a respective empirical speed (that is to say an empirical speed value) may be determined for all pairs of (directly consecutive) path points. This makes it possible to determine an empirical speed profile of vehicles along the reference profile of the road section.

The empirical speed between the first path point and the second path point may be determined as follows. It is possible to determine first speed values for the one or more corresponding first path points of the first subset of measured driving paths from which the first path point of the first reference profile was determined. It is also possible to determine second speed values for the one or more corresponding second path points of the first subset of measured driving paths from which the second path point of the first reference profile was determined. The empirical speed for the segment of the first reference profile may then be determined on the basis of the first and second speed values, in particular on the basis of a (possibly trimmed) average of the first and/or second speed values.

The device may be configured to provide the first reference profile, in particular together with the profile of the empirical speed along the first reference profile, as map data in relation to the core road section for a digital (HD) map. This makes it possible to efficiently implement automated driving functions on the basis of the digital (HD) map.

The reference profile provided for a road section may relate to a profile of the road section that is made up as a whole of the measured driving paths for this road section (without division into different lanes). This makes it possible to efficiently determine and provide a (relatively rough) profile of the road section (possibly depending on the preceding and/or following direction of travel of vehicles, that is to say possibly depending on the respective section sequence).

On the other hand, the reference driving paths determined and provided for the road section may each relate to different lanes of the road section. The reference driving paths for the road section are thus able to precisely describe the different (effective) lanes of the road section (possibly depending on the preceding and/or following direction of travel of vehicles, that is to say possibly depending on the respective section sequence).

Typically only a single reference profile is thus determined for a road section (and possibly for a particular section sequence, even if the road section has multiple lanes). On the other hand, multiple reference profiles for different lanes are determined for the road section (and possibly for the particular section sequence).

According to a further aspect, a description is given of a (road-bound) motor vehicle (in particular a passenger car or a truck or a bus or a motorcycle) that comprises one or more of the devices and/or control units described in this document.

According to a further aspect, a description is given of a central unit, for example a server, that comprises one or more of the devices described in this document.

According to a further aspect, a description is given of a method for determining a reference driving path for a road section. The method comprises determining a multiplicity of measured driving paths of one or more vehicles for a corresponding multiplicity of runs through the road section, and dividing a profile of the road section into a sequence of interpolation point planes. The method furthermore comprises determining, for each of the multiplicity of measured driving paths, a respective sequence of points of intersection of the respective measured driving path with the corresponding sequence of interpolation point planes. The method furthermore comprises determining, for each of the sequence of interpolation point planes, a respective set of interpolation points on the basis of the determined points of intersection with the respective interpolation point plane, and determining at least one reference driving path for the road section on the basis of the sequence of sets of interpolation points for the corresponding sequence of interpolation point planes.

According to a further aspect, a description is given of a method for determining a reference driving path for a core road section. The method comprises determining a multiplicity of measured driving paths of one or more vehicles for a corresponding multiplicity of runs through the core road section. The method furthermore comprises assigning each of the multiplicity of measured driving paths to a respective section sequence from a set of different section sequences in order to determine a respective subset of measured driving paths for each section sequence from the set of section sequences. In this case, the different section sequences may each contain the core road section and at least one surrounding road section arranged directly in front of and/or directly behind the core road section in the direction of travel. The method furthermore comprises determining, for each section sequence from the set of section sequences, a reference driving path for the core road section on the basis of the respective subset of measured driving paths.

According to a further aspect, a description is given of a method for the at least partially automated longitudinal and/or transverse guidance of a vehicle along a driving route through a road network. The method comprises determining, in particular on the basis of map data from a digital map of the road network, for a future run through a core road section of the road network on the driving route, a set of different reference driving paths for a corresponding set of different section sequences. In this case, the different section sequences may each contain the core road section and at least one surrounding road section arranged directly in front of and/or directly behind the core road section in the direction of travel of the vehicle. The method furthermore comprises identifying a section sequence from the set of different section sequences on the basis of the driving route, and determining a target trajectory of the vehicle for at least partially automated longitudinal and/or transverse guidance of the vehicle in the run through the core road section on the basis of the reference driving path for the identified section sequence.

According to a further aspect, a description is given of a method for determining a reference driving path for a road section. The method comprises determining a multiplicity of measured driving paths of one or more vehicles for a corresponding multiplicity of runs through the road section, and determining a reference profile of the road section on the basis of the multiplicity of measured driving paths. The method furthermore comprises arranging a sequence of interpolation point planes along the reference profile, and determining, for each of the multiplicity of measured driving paths, a respective sequence of points of intersection of the respective measured driving path with the corresponding sequence of interpolation point planes. The method furthermore comprises determining at least one reference driving path for the road section on the basis of the multiplicity of determined sequences of points of intersection for the corresponding multiplicity of measured driving paths.

According to a further aspect, a description is given of a method for determining a reference profile of a core road section. The method comprises determining a multiplicity of measured driving paths of one or more vehicles for a corresponding multiplicity of runs through the core road section. The method furthermore comprises assigning a first subset of measured driving paths from the multiplicity of measured driving paths to a first section sequence from a set of different section sequences. In this case, the different section sequences may each contain the core road section and at least one surrounding road section arranged directly in front of and/or directly behind the core road section in the direction of travel. The method furthermore comprises determining a first reference profile of the core road section for the first section sequence on the basis of the first subset of measured driving paths for the first section sequence.

According to a further aspect, a description is given of a software (SW) program. The SW program may be configured to be executed on a processor and thereby to carry out one or more of the methods described in this document.

According to a further aspect, a description is given of a storage medium. The storage medium may comprise an SW program that is configured to be executed on a processor and thereby to carry out one or more of the methods described in this document.

It should be noted that the methods, devices and systems described in this document may be used both on their own and in combination with other methods, devices and systems described in this document. Moreover, any aspects of the methods, devices and systems described in this document may be combined with one another in a wide variety of ways. In particular, the features of the claims may be combined with one another in a wide variety of ways. Features introduced in parentheses should also be understood as being optional features.

The invention is described in more detail below with reference to exemplary embodiments.

### BRIEF DESCRIPTION OF THE DRAWINGS

FIG. 1a shows an exemplary system for determining reference driving paths for a road section;

FIG. 1b shows an exemplary road section containing multiple effective lanes;

FIG. 2a shows exemplary measured driving paths for the road section illustrated in FIG. 1b;

FIG. 2b shows exemplary points of intersection and interpolation points within a plane of a road section;

FIG. 2c shows exemplary interpolation points for the sequence of planes of a road section;

FIG. 2d shows exemplary reference driving paths for the road section illustrated in FIG. 1b;

FIG. 3 shows a flowchart of an exemplary method for determining a reference driving path for a road section;

FIG. 4a shows exemplary measured driving paths at a road intersection;

FIG. 4b shows an exemplary juxtaposition of reference driving paths for consecutive road sections;

FIG. 5a shows a flowchart of an exemplary method for determining a reference driving path for a road section;

FIG. 5b shows a flowchart of an exemplary method for determining a target trajectory for a vehicle;

FIG. 6 shows exemplary interpolation points for reference driving paths in consecutive road sections;

FIG. 7 shows an exemplary sequence of planes along a reference profile of a road section;

FIG. 8a shows a flowchart of an exemplary method for determining a reference driving path for a road section; and

FIG. 8b shows a flowchart of an exemplary method for determining a reference profile of a road section.

### DETAILED DESCRIPTION OF THE DRAWINGS

As explained at the outset, the present document deals with efficiently and reliably determining one or more reference driving paths for a road section of a road network. In this case, for example, in each case different reference driving paths may be determined for different lanes of the road section. The determined reference driving paths may be provided as map data in an HD map for the road network. In particular, the one or more determined reference driving paths may be used to determine target trajectories for the automated longitudinal and/or transverse guidance of vehicles.

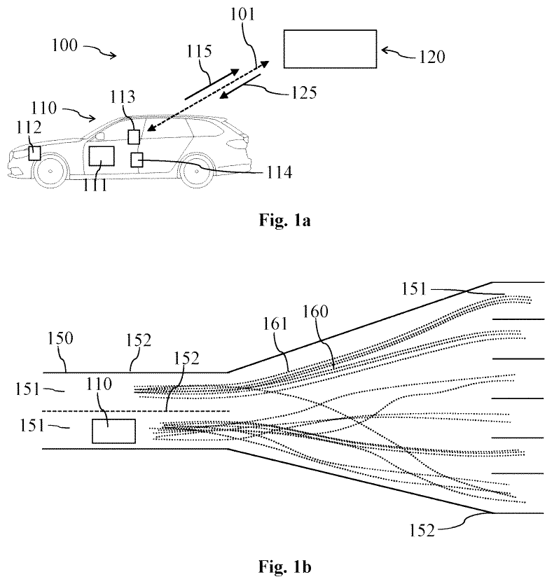

FIG. 1a shows an exemplary system 100 for determining at least one reference driving path for at least one road section of a road network. The system 100 comprises a central unit 120 that is configured to determine measurement data 115 from a multiplicity of vehicles 110 and/or for a multiplicity of runs through a road section. The measurement data 115 for a run and/or from a vehicle 110 may be received from the respective vehicle 110 via a (wireless) communication connection 101. The measurement data 115 for a run of a vehicle 110 may indicate a measured driving path of the vehicle 110 through the road section (for example as a sequence of measurement points along the driving path driven by the vehicle 110).

The central unit 120 (which is also referred to in general as a device in this document) may be configured, on the basis of the measurement data 115 from a multiplicity of vehicles 110 and/or for a multiplicity of runs through the road section, to determine at least one reference driving path for this road section. The reference driving path may describe the typical driving path of vehicles 110 in a run through the road section. In this case, different reference driving paths may be determined for different lanes of the road section. The one or more determined reference driving paths for the road section may be provided by the central unit 120 as map data 125 of a digital (HD) map for the road section (for instance transmitted to one or more vehicles 110 via a communication connection 101).

A vehicle 110 may comprise a position sensor 114 that is configured to record data in relation to the position of the vehicle 110 on the basis of a global satellite-based navigation system (GNSS). The vehicle 110 may furthermore comprise one or more sensors 112 (such as for example a speed sensor, an inertial measurement unit (IMU), one or more cameras, a wheel speed sensor, a steering sensor, etc.) that are designed to record sensor data able to be used for odometry-based determination of the position of the vehicle 110.

A control unit 111 of the vehicle 110 may be configured, on the basis of the data from the position sensor 114 and/or on the basis of the sensor data from the one or more sensors 112, to determine the position of the vehicle 110 in a run through a road section. A sequence of measurement points of the position of the vehicle 110 may in particular be determined along the profile of the road section, wherein the sequence of measurement points describes the driving path actually driven by the vehicle 110. This driving path is referred to as a “measured driving path” in this document. The sequence of measurement points of the measured driving path may be provided by the vehicle 110 as measurement data 115 (for example via a communication unit 113 of the vehicle 110). The sequence of measurement points may for example have a sampling rate or a spatial resolution of 1 measurement point per meter or higher.

FIG. 1b shows exemplary measured driving paths 160 for a road 150 (which may be divided into one or more road sections). The individual measured driving paths 160 each comprise a sequence of measurement points 161. The road 150 may have road markings 152 that indicate the edge of the road and/or a division of the road 150 into multiple lanes 151 optically and/or in a manner able to be recorded using sensors.

The driving path 160 actually driven by a vehicle 110 may correspond roughly to the center line of a lane 151 of the road 150, in particular when the road 150 has a straight profile. On the other hand, ahead of a curve for example, there may be substantial deviations between the center line of a lane 151 and the driving path 160 of a vehicle 110 that is actually driven. Furthermore, some roads 150 do not have road markings 152 for division into lanes 151, such as for example ahead of a toll station or at an intersection. In this case, it is not possible to determine any center lines of lanes 151 as reference driving paths on the basis of road markings 152 recorded using sensors.

As explained at the outset, the center line of a lane 151 may be used as target trajectory for the automated longitudinal and/or transverse guidance of a vehicle 110. As explained in FIG. 1b, it may be the case in some road sections that there are no road markings 152 for determining lanes 151, and it is thus not possible to determine a target trajectory. Furthermore, in some road sections (for example before or after a curve), the center line of a lane 151 may be unsuitable as a reference trajectory for bringing about driving behavior that is typical and accordingly comfortable for manually driven vehicles 110 in the case of automated driving.

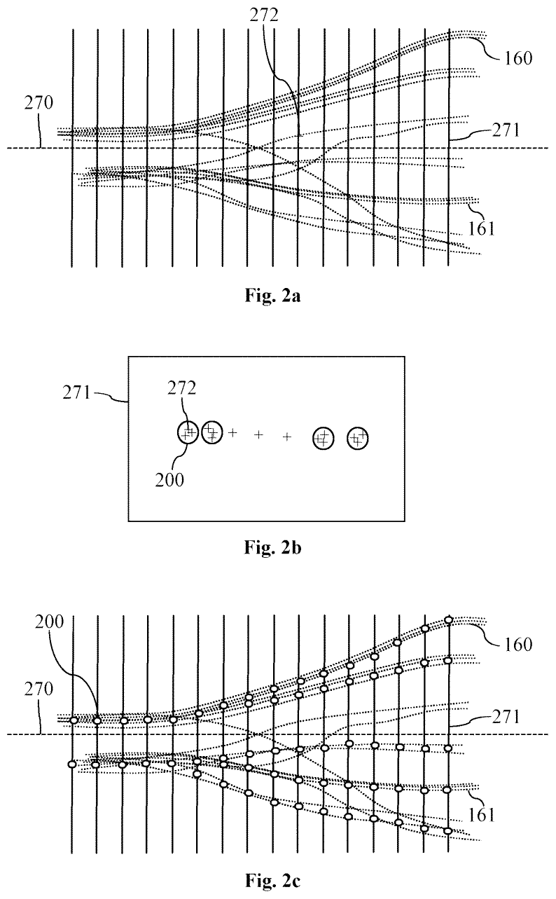

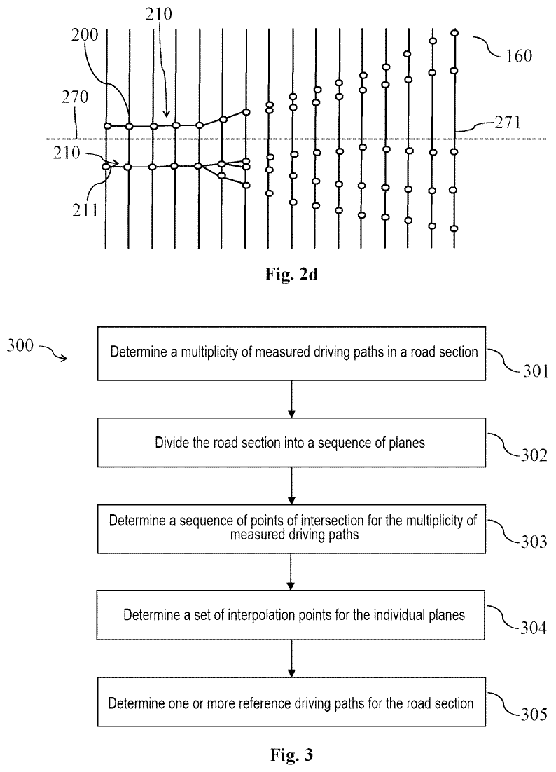

FIG. 2a shows the multiplicity of measured driving paths 160 determined for the road section from FIG. 1b. It will be assumed here that the road 150 illustrated in FIG. 1b corresponds to a (single) road section. The central unit 120 may be configured to determine a profile 270 of the road section on the basis of a digital (SD) map. This profile 270 may be referred to as map profile of the road section. The map profile 270 may be used as reference for dividing the road section into a sequence of (interpolation point) planes 271. In particular, planes 271 may be arranged in each case perpendicular to the map profile 270 at a certain distance (for example between 1 and 3 meters, for instance 2 meters) and used to divide the measured driving paths 160 accordingly into a respective sequence of points of intersection.

The individual planes 271 intersect the different measured driving paths 160. A measured driving path 160 may thus be divided into a corresponding sequence of points of intersection by the sequence of planes 271 along the map profile 270.

FIG. 2b shows the multiplicity of points of intersection 272 for a corresponding multiplicity of measured driving paths 160 within an exemplary plane 271 of the sequence of planes 271 for a road section. The central unit 120 may be configured to convert the multiplicity of points of intersection 272 of a plane 271 into a set of interpolation points 200 for a corresponding set of reference driving paths for the road section using a clustering algorithm. The DBSCAN algorithm may for example be used as clustering algorithm.

The central unit 120 may be configured, in the same way for the sequence of planes 271 of the road section, to determine a respective multiplicity of points of intersection 272 and, based thereon, a set of interpolation points 200, as illustrated for example in FIG. 2c. In this case, the number of interpolation points 200 in the different planes 271 may differ at least partially from one another. The change in the number of interpolation points 200 in different planes 271 may for example be down to the fact that driving paths merge into one another along the road section or that one driving path along the road section splits into multiple driving paths (as may be the case for example when entering a toll station).

As is apparent from FIG. 2c, a respective set of one or more interpolation points 200 may be determined on the basis of the measured driving paths 160 for the individual planes 271 of the sequence of planes 271. The central unit 120 may be configured to determine one or more reference driving paths 210 for the road section on the basis of the sequence of sets of interpolation points 200 (as illustrated for example in FIG. 2d). For this purpose, an interpolation point 200 from the respective plane 271 may be joined, by a path segment 211, to an interpolation point 200 from the respective directly following plane 271 along the sequence of planes 271 (in the direction of travel of the road section), starting from the first plane 271. At least one sequence of interpolation points 20 for the corresponding sequence of planes 271 may thus be determined and joined sequentially with path segments 211 in order to determine a reference driving path 210. In the example illustrated in FIG. 2d, a total of 5 different reference driving paths 210 may be determined, wherein the reference driving paths 210 overlap in partial segments of the road section.

As already explained, the center line of a lane 151 typically cannot be recorded directly using sensors. The center line of a lane 151 is therefore typically defined and determined as the center between adjacent lane boundaries and/or lane markings 152. However, this may lead to determining lane center lines between markings 152 that do not at all delimit lanes 151 that actually exist. This may be the case for example for the center between a flow and contraflow direction of a motorway that is not separated by structures. Using the measures described in this document, it is possible to reliably avoid determining non-existent lane center lines, thereby making it possible to increase the quality of autonomous driving functions.

Within larger motorway toll stations, within intersections or else on many country roads, lane markings 152 are not present to the extent required to determine lane center lines based thereon. The same applies for entrances to intersections with separate lanes 151 that are not separated by a marking 152 for each turning direction. The measures described in this document make it possible to precisely determine reference driving paths 210 for roads 150 without or with only insufficient lane markings 152.

Human drivers typically do not follow the lane center line of a lane 151 in all situations, but rather optimize the trajectory of the vehicle 110 according to aspects other than the distance from adjacent traffic in one or more neighboring lanes 151 as well. Examples of this are cutting corners, pulling out in a turning maneuver or avoiding bumps such as potholes. The lane center line is therefore often not optimum as a target variable for the trajectory planning of a vehicle 110 (that is to say as a target trajectory). The measures described in this document make it possible to determine reference driving paths 210 able to be used for optimized trajectory planning (since the reference driving paths 210 replicate the typical driving behavior of manual drivers).

The method described in this document processes discrete measurement points 161 along the measured trajectories 160 (that is to say the measured driving paths) of actual runs through a road section. This makes it possible to determine a reference driving path 210 for each lane 151 independently of the existence of lane markings 152, which reference driving path may replace the lane center line as target variable for the trajectory planning as a representation of natural driver behavior.

There is a single estimated and/or measured sequence 160 of vehicle positions 161 (that is to say a measured driving path 160) per run. A clustering algorithm may be used to assign the point of intersection 272 of a measured driving path 160 with a plane 271 perpendicular to the road profile 270 to the corresponding points of intersection 272 of the other measured driving paths 160.

The individual runs through a road section typically differ from one another due to natural driver behavior and due to a multiplicity of environmental influences. To improve reliability and accuracy in terms of determining a reference driving path 210 along a lane, it is possible to carry out measures in order to reduce the influence of interfering influences. It is in particular possible, as one measure, when combining the points of intersection 272 of the measured trajectories 160 with the planes 271 perpendicular to the road profile 270 (possibly for each coordinate), to form an average (in particular what is known as a trimmed average) that is cleaned from outliers. The central unit 120 may thus be designed to identify outliers when determining the interpolation points 200 and to leave them unconsidered in order to increase the accuracy of the determined interpolation points 200.

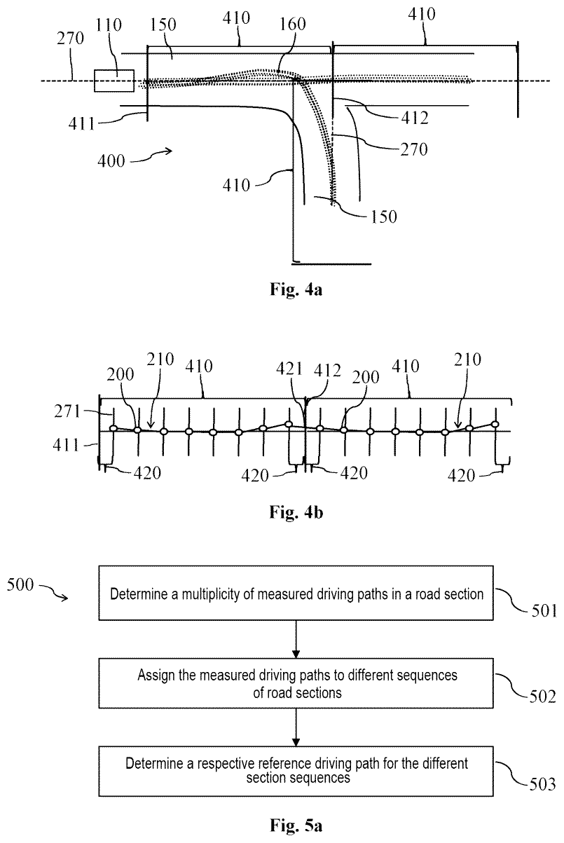

FIG. 3 shows a flowchart of a (possibly computer-implemented) method 300 for determining a reference driving path 210 for a road section 410 (in a road network). A road section 410 is illustrated by way of example in FIG. 4a. The method 300 comprises determining 301 a multiplicity of measured driving paths 160 of one or more vehicles 110 for a corresponding multiplicity of runs through the road section 410. The measured driving paths 160 may in this case each indicate the trajectory that the individual vehicles 110 actually drove in the respective run through the road section 410.

The method 300 furthermore comprises dividing 302 a profile 270, 700 (for example the map profile 270 or a reference profile 700 described in connection with FIG. 7) of the road section 410 into a sequence of interpolation point planes 271. In other words, interpolation point planes 271 may be placed (at equal distances) along the profile 270, 700 (in each case perpendicular to the profile 270, 700). The interpolation point planes 271 may in this case each be two-dimensional. The profile 270, 700 of the road section 270 and/or the measured driving paths 160 may be described in three-dimensional space.

The method 300 furthermore comprises determining 303, for each of the multiplicity of measured driving paths 160, a respective sequence of points of intersection 272 of the respective measured driving path 160 with the corresponding sequence of interpolation point planes 271. In other words, it is possible to determine where the individual measured driving paths 160 each intersect the interpolation point planes 271 and thus form points of intersection 272.

The method 300 furthermore comprises determining 304, for each of the sequence of interpolation point planes 271, a respective set of interpolation points 200 on the basis of the determined points of intersection 272 with the respective interpolation point plane 271. For this purpose, one or more clusters of points of intersection 272 may be determined in each individual interpolation point plane 271 on the basis of a clustering algorithm. Furthermore, a respective interpolation point 200 may be determined on the basis of each cluster (for example as a (possibly trimmed) average of the points of intersection 272 in the cluster).

The method 300 furthermore comprises determining 305 at least one reference driving path 210 for the road section 410 on the basis of the sequence of sets of interpolation points 200 for the corresponding sequence of interpolation point planes 271. For this purpose, it is possible to determine one or more continuous sequences of interpolation points 200 along the sequence of interpolation point planes 271 and for these each to be connected to one another via path segments 211. The individual continuous sequences of interpolation points 200 then each form a reference driving path 210.

In the case of a fork in a road 150 (for example at an exit or at an intersection) into two different adjoining roads 150 with different orientations, the measured driving paths 160 of vehicles 110 in a road section may differ depending on whether the vehicle 110 then drives onto the road section into the first adjoining road 150 or into the second adjoining road 150. By way of example, at a turning, the measured driving paths 160 of vehicles 110 driving straight ahead may differ (statistically) from the measured driving paths 160 of vehicles 110 that turn off. This is illustrated for example for a turning situation 400 in FIG. 4a. FIG. 4a in particular shows a (core) road section 410 followed by a following first (surrounding) road section 410 (when driving straight ahead) and followed by a second (surrounding) road section 410 (when turning right).

It is particularly clear from FIG. 4a that the measured driving paths 160 in the (core) road section 410 prior to the turn differ depending on whether a vehicle 110 drives straight ahead or turns off following this (core) road section 410. The measured driving paths 160 in a (core) road section 410 may thus depend on the one or more following (surrounding) road sections 410 in which the respective measured driving path 160 runs.

Accordingly, the measured driving paths 160 for a (core) road section 410 may depend on one or more preceding (surrounding) road sections 410 through which the respective measured driving path 160 ran.

The central unit 120 may be configured, for a (core) road section 410, to determine multiple different reference driving paths 210 for different preceding and/or following (surrounding) road sections 410. In particular, for a specific core road section 410, it is possible to determine (for example on the basis of the data from an (SD) map) all possible section sequences of directly consecutive road sections 410 containing a certain number N of surrounding road sections 410 before the particular core road section 410 and/or a certain number M of surrounding road sections 410 after the particular core road section 410. N and/or M may each be 1 or more, or 2 or more. It is then possible to determine a reference driving path 210 in the particular core road section 410 for each possible section sequence of road sections 410 (which each comprise the particular core road section 410). If Q different possible section sequences of road sections 410 exist for the particular core road section 410, it is thus possible to determine Q different reference driving paths 210 (for example Q greater than 1, or Q greater than 2).

For this purpose, the central unit 120 may be configured to assign the multiplicity of available measured driving paths 160 for the particular core road section 410 in each case to one of the Q sequences of road sections 410. In the example illustrated in FIG. 4a, the measured driving paths 160 in the straight-ahead direction would thus be assigned to a first sequence of road sections 410 and the measured driving paths 160 in the turning-right direction would be assigned to a second sequence of road sections 410.

It is thus possible to determine a respective subset of measured driving paths 160 for each sequence of road sections 410. Based on the respective subset of measured driving paths 160, it is then possible to determine a respective reference driving path 210 (using the method 300 described in this document). The Q reference driving paths 210 may then be provided as map data 125 for the particular road section 410. During operation of a (self-driving) vehicle 110, the sequence of road sections 410 of the driving route of the vehicle 110 may then be determined. For the run through the particular core road section 410, the reference driving path 210 appropriate therefor may then be selected (and used to determine the target trajectory of the vehicle 110 for the run through the core road section 410).

To chain reference driving paths 210 of consecutive road sections 410, it may be advantageous (as illustrated by way of example in FIG. 4b) to provide a distance 420 between the end point of the reference driving path 210 of a road section 410 and the end or end point 412 of the road section 410. Provision may also accordingly be made for a distance 420 between the start or starting point 411 of the road section 410 and the start or starting point of the reference driving path 210 of the road section 410. The distance 420 may for example correspond to half the distance between two consecutive planes 271. The starting point of a reference driving path 210 may correspond to the interpolation point 200 of the first interpolation point plane 271 and/or the end point of a reference driving path 210 may correspond to the interpolation point 200 of the last interpolation point plane 271 (each in relation to the direction of travel through the road section 410).

As illustrated in FIG. 4b, the last interpolation point 200 of the reference driving path 210 of a road section 410 is at a certain distance 420 from the end 412 of the road section 410. Furthermore, the first interpolation point 200 of the reference driving path 210 of the adjoining road section 410 is at a certain distance 420 from the start 411 of the adjoining road section 410. A (possibly linear) joining segment 421 may then be inserted between these two interpolation points 200 of the reference driving path 210 in order to determine a chained reference driving path for the juxtaposition of the road sections 410.

As illustrated in FIG. 4a, in the case of forks in the road network, the natural driving paths 160 may differ for example between those driving straight ahead and those turning right within the same lane 151. The measures described in this document make it possible to reliably avoid determining incorrect reference driving paths 210 based on averages of different groups of natural driving paths 160. It is also possible to avoid discontinuities between the reference driving paths 210 of consecutive road sections 410. The described measures in particular make it possible to bring about consistent transitions between the reference driving paths 210 of consecutive road sections 410.

As described in this document, the method 300 may be applied not only for each road section 410, but separately for each road section 410 and for each driven sequence of road sections 410. In this case, consideration may be given to a core road section 410 (for which the measured driving paths 160 are evaluated). Consideration may also be given to a sequence of driven road sections 410 in the surroundings of the core road section 410. The surroundings may in this case be defined by the maximum overall length of the juxtaposed road sections 410 (in each case in front of and/or behind the core road section 410). The maximum overall length may for example be between 100 and 200 meters. A road section 410 may have a length between 20 and 50 meters. Consideration may thus be given to sequences of road sections 410 having in each case 4 or more road sections 410.

In order to enable a consistent transition between driving paths 210 of consecutive road sections 410, the planes 271 perpendicular to the road profile 270 of a road section 410 might possibly not be evaluated along the entire running length of the road section 410, but rather a certain distance 420 may be maintained at the edges 411, 412, for example in each case half the distance between two planes 271. In this way, when the reference driving paths 210 of the individual road sections 410 are combined to form a consistent map for the road network, it is possible to insert consistent transitions 421 between the reference driving paths 210 of the individual road sections 410.

The transitions 421 may be inserted such that the reference driving paths 210 of a road section 410 are extended with the first position point of the respective following reference driving path 210, with knowledge of the determined reference driving paths 210 of the surrounding (in particular adjoining) road sections 410, only in the direction of travel. Each reference driving path 210 is thus able to be extended on its own and the process for inserting transitions 421 may be parallelized.

The association between consecutive reference driving paths 210 may in this case be determined based on geospatial distance metrics (position and/or orientation) of the respective start and end points of the reference driving paths 210. As an alternative or in addition, the Jaccard distance may be used as criterion for the assignment of reference driving paths 210 in consecutive road sections 410. In this case, the Jaccard distance may be determined on the basis of the measured trajectories 160 from which the potentially consecutive reference driving paths 210 were determined.

FIG. 5a shows a flowchart of a (possibly computer-implemented) method 500 for determining a reference driving path 210 for a core road section 410 (that is to say for a road section 410 that is denoted as a core road section to clarify the description of the method 500). The method 500 comprises determining 501 a multiplicity of measured driving paths 160 of one or more vehicles 110 for a corresponding multiplicity of runs through the core road section 410.

The method 500 furthermore comprises assigning 502 each of the multiplicity of measured driving paths 160 to a respective section sequence from a set of different section sequences in order to determine a respective subset of measured driving paths 160 for each section sequence from the set of section sequences. In this case, the different section sequences may each contain the core road section 410 and at least one surrounding road section 410 arranged directly in front of and/or directly behind the core road section 410 in the direction of travel. The section sequences may thus each contain one or more road sections 410.

The method 500 furthermore comprises determining 503, for each section sequence from the set of section sequences, a reference driving path 210 for the core road section 410 on the basis of the respective subset of measured driving paths 160. The method 300 may for example be used for this purpose.

FIG. 5b shows a flowchart of a (possibly computer-implemented) method 510 for the at least partially automated longitudinal and/or transverse guidance of a vehicle 110 along a driving route through a road network. The method 510 may be carried out by a control unit 111 of the vehicle 110.

The method 510 comprises determining 511, in particular on the basis of map data 125 from a digital map of the road network (for instance an HD map), for a future run through a core road section 410 of the road network on the driving route, a set of different reference driving paths 210 for a corresponding set of different section sequences. The method 510 furthermore comprises identifying 512 a section sequence from the set of different section sequences on the basis of the driving route. It is in particular possible to determine the section sequence that corresponds to the driving route, that is to say along which the driving route runs.

The method 510 furthermore comprises determining 513 a target trajectory of the vehicle 110 for at least partially automated longitudinal and/or transverse guidance of the vehicle 110 in the run through the core road section 410 on the basis of the reference driving path 210 for the identified section sequence.

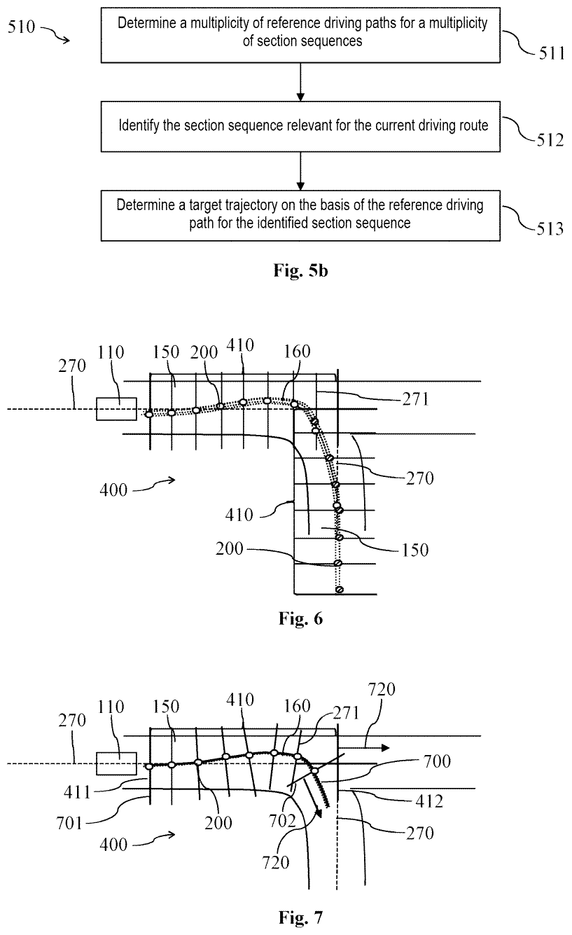

Determining reference driving paths 210 for a sequence of road sections 410 that have a relatively large curvature (for instance due to a turning situation) may lead to significant discontinuities at the transitions between the reference driving paths 210 for directly consecutive road sections 410. This is illustrated by way of example in FIG. 6. FIG. 6 in particular shows the interpolation points 200 of the reference driving path 210 for a first road section 410 (each illustrated as white circles) and the interpolation points 200 of the reference driving path 210 for an adjoining second road section 410 (each illustrated as hatched circles). The profile 270 of the second road section 410 is in this case substantially perpendicular to the profile 270 of the first road section 410. This leads to the interpolation point planes 271 for the second road section 410 being arranged substantially perpendicular to the interpolation point planes 271 for the first road section 410.

As is apparent from FIG. 6, due to the relatively great divergence between the orientation of the interpolation point planes 271 and the profile of the measured driving paths 160, there may be overlaps and/or discontinuities between one or more interpolation points 200 at the end 412 of the first road section 410 and one or more interpolation points 200 at the start 411 of the following second road section 410. This may in turn lead to inconsistencies at the transition between the reference driving paths 210 of the two road sections 410.

As illustrated by way of example in FIG. 7, the central unit 120 may be configured, on the basis of the measured driving paths 160 for a road section 410, to determine a reference profile 700 of the road section 410. By way of example, the measured driving paths 160 may be averaged (possibly without considering one or more outliers) in order to determine the reference profile 700. The reference profile 700 may then be used instead of the map profile 270 of the road section 410 in order to determine the sequence of interpolation point planes 200 for the road section 410. The individual interpolation point planes 200 may in this case each be arranged perpendicular to the reference profile 700.

The method 300 described in connection with FIG. 3 and FIGS. 2a to 2d may accordingly be used to determine the interpolation points 200 for a reference driving path 210. This makes it possible to increase the accuracy of the determined reference driving path 210, in particular in relation to the transition to the reference driving path 210 for the following road section 410.

As is apparent from FIG. 7, the start 411 (that is to say the starting point or the position of the starting point) of the map profile 270 of the road section 410 for which a driving path 210 is to be determined may differ from the start 701 (that is to say from the starting point or from the position of the starting point) of the corresponding reference profile 700. As an alternative or in addition, the end 412 (that is to say the end point or the position of the end point) of the map profile 270 of the road section 410 may differ from the end 702 (that is to say from the end point or from the position of the end point) of the corresponding reference profile 700. The central unit 120 may be configured to determine the start 701 and/or the end 702 of the reference profile 700 such that a particular distance criterion or distance metric is reduced, in particular minimized. The distance criterion may depend on the distance of the respective point 701, 702 of the reference profile 700 from the corresponding point 411, 412 of the map profile 270. As an alternative or in addition, the distance criterion may depend on the deviation of the orientation 720 of the start 701 or the end 702 of the reference profile 700 from the orientation 720 of the start 411 or the end 412 of the map profile 270. The start 701 and/or the end 702 of the reference profile 700 may thus be determined such that the distance from the start 411 and/or from the end 412 of the map profile 270 is as small as possible and/or that the orientation 720 of the start 701 and/or the end 702 of the reference profile 700 is as similar as possible to the orientation 720 of the start 411 and/or the end 412 of the map profile 270.

As explained in this document, the driving paths 210 for each road section 410 may be determined depending on the sequence of driven road sections 410, that is to say effectively on the turning direction.

When generating driving paths 210 from fleet data 115 from a multiplicity of vehicles 110, it is possible to use the road geometry contained in an SD map, that is to say the map profile 270, in order to construct cross-sectional planes 271 perpendicular to the road profile 270 for which the passage points 272 of the measured trajectories 160 of a set of runs through the respective road section 410 are determined. The passage points 272 are combined for each plane 271 (to form one or more interpolation points 200) and the one or more interpolation points 200 are joined between the planes 271 (by path segments 211) in order to determine representations of one or more reference driving paths 210.

Restrictions in terms of representing the road geometry and/or the curvature profile in an SD map may lead to turning paths at an intersection not being able to be learned correctly, because the constructed planes 271 only partially intersect the measured trajectories 160 of the runs and/or because the sequence of constructed planes 271 along the road geometry 270 results in points of intersection 272 with a measured trajectory 160 whose running coordinates along this measured trajectory 160 are not monotonically rising or falling.

This document describes a method for determining the road profile geometry from fleet data 115, wherein, in the course of the method, it is possible to draw a distinction according to direction of travel and turning direction at intersections, such that the actual curvature profile of roads 150 is able to be represented considerably better than is the case with SD maps.

The starting point is a set of measured trajectories 160 of runs through the same (core) road section 410. In this case, the set of measured trajectories 160 may relate to trajectories that all follow the same sequence of road sections 410 in the surroundings of the core road section 410 and/or that all have the same turning direction (when an intersection is arranged in the surroundings of the core road section 410).

In a first step, the measured trajectories 160 of the runs may be tailored such that all trajectories 160 cover the same section 410 in the road network. For this purpose, each point 161 of a measured trajectory 160 may be assigned a road section 410 of the SD map in accordance with predetermined criteria. In this process, referred to as map matching, spatial proximity, orientation or associations between surrounding points may be used as assignment criteria. A measured trajectory 160 may be tailored so as to determine the running coordinates along the measured trajectory 160 for the last point before and for the first point after a reference point 411, 412 in the road network of the SD map and then, on the basis of the running coordinates of the measured trajectory 160 and on the basis of the running coordinates in the SD road network, to determine the running coordinate of the measured trajectory 160 at which the measured trajectory 160 is to be intersected. The measured trajectory 160 of a run through a particular road section 410 may thus be determined on the basis of the measurement data 115 from a vehicle 110.

The tailoring preferably takes place not just on the core road section 410 itself, but for a region extended by a particular length (for example 15 meters) along the sequence of surrounding SD road sections. This makes it possible to increase the robustness of the method.

For the tailored measured trajectories 160 for a (core) road section 410, it is possible to define common relative running lengths, that is to say running lengths with respect to the overall length of the respective tailored trajectory 160 (for example 0%, 10%, 20%, . . . , 100% of the respective overall length). A respective position may be determined, in particular interpolated, at corresponding locations on the respective running lengths for each trajectory 160. The positions, thus determined, of the same relative running length of all trajectories 160 may then be combined and a representative position for this relative running length may be determined therefrom. It is possible to use averaging for each coordinate here. Advantageously, outliers are moved in the process, for example using the median or by forming a trimmed average (for example removing the highest and lowest 10% of all values before averaging).

The sequence of positions thus determined may be interpreted as a polyline or pre-stage for the improved road profile geometry. In this document, this sequence is also referred to as reference profile 700 of the core road section 410. If the trajectories 160 have been tailored to a region extended in relation to the core road section 410, the start 701 and the end 702 of the road profile geometry 700 to be assigned to the core road section 410 may still be determined. This may be achieved for example through an orthogonal projection of start 411 and end 412 of the core road section 410 onto the newly determined road profile geometry 700.

In particular in the case of turning maneuvers (for instance in the case of a so-called U-turn), it may be the case that the determined transition point 702 to the following road section 410 depends relatively greatly on the geometric position of the determined road profile geometry 700. The end 702 of the road section 410 may in this case differ relatively greatly from the start 701 of the following section 410, resulting in a jump in the road profile. To avoid this, it is possible to select a point along the determined road profile geometry 700 as a start or end point 701, 702 that does not just have the smallest possible distance from the corresponding points 411, 412 on the SD map, but also that additionally also corresponds as well as possible to the corresponding points 411, 412 in terms of its orientation 720. If the geometry in the SD map is represented by polylines, the orientation 720 of the point 411, 412 on the SD map may be determined as an average orientation of the two adjoining line segments.

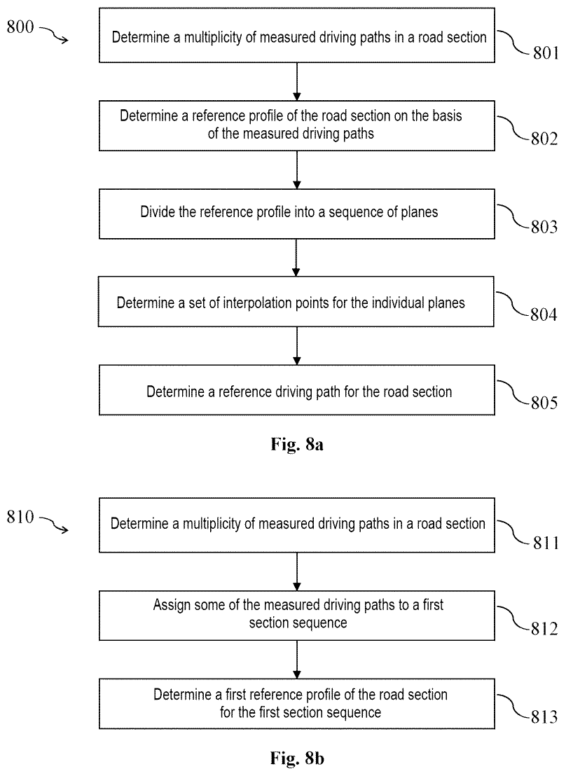

FIG. 8a shows a flowchart of a (possibly computer-implemented) method 800 for determining a reference driving path 210 for a road section 410. The method 800 comprises determining 801 a multiplicity of measured driving paths 160 of one or more vehicles 110 for a corresponding multiplicity of runs through the road section 410. The method 800 furthermore comprises determining 802 a reference profile 700 of the road section 410 on the basis of the multiplicity of measured driving paths 160. This reference profile 700 may then be used as a profile 270, 700 in the method 300 in order to determine at least one reference driving path 210 for the road section 410.

The method 800 may thus in particular comprise arranging 803 a sequence of interpolation point planes 271 along the reference profile 700, and determining 804, for each of the multiplicity of measured driving paths 160, a respective sequence of points of intersection 272 of the respective measured driving path 160 with the corresponding sequence of interpolation point planes 271. The method 800 may furthermore comprise determining 805 at least one reference driving path 210 for the road section 410 on the basis of the multiplicity of determined sequences of points of intersection 272 for the corresponding multiplicity of measured driving paths 160.

FIG. 8b shows a flowchart of a (possibly computer-implemented) method 810 for determining a reference profile 700 of a core road section 410 (that is to say a road section referred to as core road section). The method 810 comprises determining 811 a multiplicity of measured driving paths 160 of one or more vehicles 110 for a corresponding multiplicity of runs through the core road section 410.

The method 810 furthermore comprises assigning 812 a first subset of measured driving paths 160 from the multiplicity of measured driving paths 160 to a first section sequence from a set of different section sequences. In this case, the different section sequences may each contain the core road section 410 and at least one surrounding road section 410 arranged directly in front of and/or directly behind the core road section 410 in the direction of travel.

The method 810 furthermore comprises determining 813 a first reference profile 700 of the core road section 410 for the first section sequence (solely) on the basis of the first subset of measured driving paths 160 for the first section sequence. The first reference profile 700 may in this case, as in this document, be determined (solely) on the basis of the first subset of measured driving paths 160.

As early as when determining the reference profile 700 for a core road section 700, it is thus possible to take into consideration the surrounding road section 700 from which a vehicle 100 drives into the core road section 700 and/or the surrounding road section 700 into which a vehicle drives from the core road section 700. It is thus possible to determine a direction of travel-dependent reference profile 700. This makes it possible to further increase the quality of the determined reference driving paths 210.

The different reference driving paths 210 for the different section sequences may in particular each be determined using the specific reference profile 700 for the respective section sequence. This makes it possible to increase the quality of the determined reference driving paths 210 to a considerable extent.

The reference profile 700 of the core road section 410 for a particular section sequence may be provided as map data for a digital map. The reference profile 700 may then for example be displayed in a head-up display of a vehicle 110 (for example as an augmented reality display) in the run through the core road section 410.

The measures described in this document make it possible to efficiently and precisely determine reference driving paths 210 for road sections 410 of a road network that are able to be provided as map data 125 for an HD map. The determined reference driving paths 210 may be used by an at least partially self-driving vehicle 110 in order to determine target trajectories for the vehicle 110. This makes it possible to increase the quality of self-driving vehicles 110.

The present invention is not restricted to the exemplary embodiments shown. It should in particular be noted that the description and the figures are intended to illustrate the principle of the proposed methods, devices and systems only by way of example.

1-14. (canceled)

15. A device for determining a reference driving path for a road section, wherein the device is configured to:
determine a plurality of measured driving paths of one or more vehicles for a corresponding plurality of runs through the road section;
divide a profile of the road section into a sequence of interpolation point planes;
for each of the plurality of measured driving paths, determine a respective sequence of points of intersection of the respective measured driving path with the corresponding sequence of interpolation point planes;
for each of the sequence of interpolation point planes, determine a respective set of interpolation points on a basis of the determined points of intersection with the respective interpolation point plane; and
determine at least one reference driving path for the road section on a basis of the sequence of sets of interpolation points for the corresponding sequence of interpolation point planes.

16. The device according to claim 15, wherein the device is configured to:
determine the set of interpolation points for an interpolation point plane on a basis of a Density-Based Spatial Clustering of Applications with Noise (DBSCAN) algorithm, for clustering the plurality of determined points of intersection with the interpolation point plane.

17. The device according to claim 15, wherein the device is configured to:
identify one or more points of intersection from the plurality of points of intersection with an interpolation point plane as outliers; and
leave the one or more points of intersection identified as outliers unconsidered when determining the set of interpolation points for the interpolation point plane.

18. The device according to claim 15, wherein the device is configured to:
determine a subset of points of intersection for an interpolation point from the plurality of determined points of intersection with an interpolation point plane on a basis of a clustering algorithm; and
determine the interpolation point as a trimmed average of the subset of points of intersection.

19. The device according to claim 15, wherein
a measured driving path of a vehicle in each case comprises a sequence of measurement points of a position of a reference point of the vehicle in a run through the road section; and/or
a measured driving path of a vehicle indicates a driving trajectory of the vehicle in a run through the road section.

20. The device according to claim 15, wherein the device is configured to:
determine a map profile of the road section recorded in a digital map based on a digital map in relation to the road section; and
use the map profile of the road section as a profile for division of the road section into the sequence of interpolation point planes.

21. The device according to claim 15, wherein the device is configured to:
determine the sequence of interpolation point planes such that:
directly consecutive interpolation point planes along the profile of the road section are each at a predefined distance from one another; and/or
the individual interpolation point planes are each arranged perpendicular to the profile of the road section.

22. The device according to claim 15, wherein the device is configured to:
sequentially along the sequence of interpolation point planes:
assign a respective interpolation point from the set of interpolation points of the respective interpolation point plane under consideration to the reference driving path to be determined; and
to join the assigned interpolation point of the respective interpolation point plane under consideration, by a path segment, to the assigned interpolation point of the preceding interpolation point plane arranged before the interpolation point plane under consideration;
so that the reference driving path is formed sequentially by the path segments between the respectively assigned interpolation points.

23. The device according to claim 22, wherein the device is configured to:
for a first interpolation point in a particular interpolation point plane from the sequence of interpolation point planes:
determine a first subset of the measured driving paths of the one or more points of intersection from which the first interpolation point of the particular interpolation point plane was determined;
determine a second subset of measured driving paths of the one or more points of intersection from which an interpolation point of another interpolation point plane that was already assigned to the reference driving path was determined; and
assign the first interpolation point to the reference driving path on a basis of a Jaccard coefficient of the first and second subset of measured driving paths.

24. The device according to claim 15, wherein the device is configured to:
determine an empirical speed for a path segment between a first interpolation point of a first interpolation point plane and a second interpolation point of a second interpolation point plane of the reference driving path, by:
determining first speed values for the one or more points of intersection of a first subset of measured driving paths from which the first interpolation point was determined;
determining second speed values for the one or more points of intersection of a second subset of measured driving paths from which the second interpolation point was determined; and
determining the empirical speed for the path segment on a basis of an average of the first and/or second speed values.

25. The device according to claim 15, wherein the device is configured to:
provide the determined reference driving path as map data in relation to the road section for a digital map.

26. The device according to claim 15, wherein
the reference driving path is designed such that the reference driving path is able to be used as target trajectory for an at least partially self-driving vehicle in a run through the road section; and/or
the reference driving path indicates a sequence of target positions of a reference point of a vehicle in a run through the road section.

27. The device according to claim 15, wherein the device is configured to:
determine the reference driving path independently of road markings of the road section that are recorded using sensors; and/or
determine the reference driving path on a basis of the plurality of measured driving paths as well when the road section does not have any road markings able to be recorded using sensors for identifying one or more lanes.

28. A method for determining a reference driving path for a road section comprising:
determining a plurality of measured driving paths of one or more vehicles for a corresponding plurality of runs through the road section;
dividing a profile of the road section into a sequence of interpolation point planes;
determining, for each of the plurality of measured driving paths, a respective sequence of points of intersection of the respective measured driving path with the corresponding sequence of interpolation point planes;
determining, for each of the sequence of interpolation point planes, a respective set of interpolation points on a basis of the determined points of intersection with the respective interpolation point plane; and
determining at least one reference driving path for the road section on a basis of the sequence of sets of interpolation points for the corresponding sequence of interpolation point planes.

29. The method according to claim 28, comprising:
determining the set of interpolation points for an interpolation point plane on a basis of a Density-Based Spatial Clustering of Applications with Noise (DBSCAN) algorithm, for clustering the plurality of determined points of intersection with the interpolation point plane.

30. The method according to claim 28, comprising:
identifying one or more points of intersection from the plurality of points of intersection with an interpolation point plane as outliers; and
leaving the one or more points of intersection identified as outliers unconsidered when determining the set of interpolation points for the interpolation point plane.

31. The method according to claim 28, comprising:
determining a subset of points of intersection for an interpolation point from the plurality of determined points of intersection with an interpolation point plane on a basis of a clustering algorithm; and
determining the interpolation point as a trimmed average of the subset of points of intersection.

32. The method according to claim 28, wherein
a measured driving path of a vehicle in each case comprises a sequence of measurement points of a position of a reference point of the vehicle in a run through the road section; and/or
a measured driving path of a vehicle indicates a driving trajectory of the vehicle in a run through the road section.

33. The method according to claim 28, comprising:
determining a map profile of the road section recorded in a digital map based on a digital map in relation to the road section; and
using the map profile of the road section as a profile for division of the road section into the sequence of interpolation point planes.

34. The method according to claim 28, comprising:
determining the sequence of interpolation point planes such that:
directly consecutive interpolation point planes along the profile of the road section are each at a predefined distance from one another; and/or
the individual interpolation point planes are each arranged perpendicular to the profile of the road section.
